(19) United States
(12) Patent Application Publication
(10) Pub. No.: US 2026/0264560 A1
(43) Pub. Date: Sep. 10, 2026

(54) Electric Automobile Charging Strategy Method Based on Time and Price Weights

(71) Applicant: Electric Power Research Institute of Hainan Power Grid Co., Ltd., Haikou (CN)

(72) Inventors: Songling PANG, Haikou (CN); Chenjia ZHANG, Haikou (CN); Hailong ZHAO, Haikou (CN)

(21) Appl. No.: 19/664,224

(22) Filed: Apr. 30, 2026

Related U.S. Application Data
(63) Continuation of application No. PCT/CN2024/107256, filed on Jul. 24, 2024.

(30) Foreign Application Priority Data
Jun. 19, 2024 (CN) 202410789940.7

(51) Int. Cl. B60L 53/64; B60L 53/63; B60L 53/67

(52) U.S. Cl. CPC B60L 53/64; B60L 53/63; B60L 53/67; B60L 2260/54; B60L 2260/58

(57) ABSTRACT

The present invention belongs to the field of electric automobile charging strategies, and particular relates to an electric automobile charging strategy method based on time and price weights. Information such as a real-time charging power and a charging duration of an automobile is acquired to calculate information entropy weight value by user-set priorities for charging time and price. According to a total electricity load, a power limit and the like in the current region, a real-time charging distribution power of the automobile is calculated based on a weight value priority; and the real-time charging power is iteratively regulated. The method can orderly charge the electric automobiles if there is an upper limit of the power limit in the region.

### CROSS-REFERENCE TO RELATED APPLICATIONS

The present application is a continuation of International Application No. PCT/CN2024/107256, filed on Jul. 24, 2024, which claims priority to Chinese Patent Application No. 202410789940.7, filed on Jun. 19, 2024, the entire disclosure of which is incorporated herein by reference.

### TECHNICAL FIELD

The present invention belongs to the technical field of electric automobile charging strategies, and particularly relates to an electric automobile charging strategy method based on time and price weights.

### BACKGROUND

The new energy automobile industry has entered a period of comprehensive upgrading. New energy automobile population accounts for 5.5% of total automobile population, but there is a strong randomness in charging behavior of electric automobiles. With the growth of the scale of the electric automobiles, a small change in charging randomness may cause a drastic change in local load, which seriously affects safe and stable running of a local distribution network.

Although users can be guided and encouraged to actively regulate their automobile usage behaviors, charging habits, etc. according to a principle of time-of-use electricity pricing set by a power grid in different regions, to a certain extent, orderly charging of the electric automobiles can be ensured. However, peak, flat and valley electricity consumption periods can only passively influence regulation of the users' charging habits by means of different pricing modes; and with the continuous increase of the electric automobile population, the users' behaviors tend to be consistent. It is still inevitable that a large number of electric automobiles are connected to the power grid in a load curve peak period. in this way, it may lead to a series of problems such as line overload of the distribution network, a voltage sag, increase in distribution network loss, overload of a distribution transformer, etc.

At present, there is a lack of interaction between one electric automobile and a charging pile as well as between one electric automobile and a charging station. Therefore, a charging power cannot be regulated, and a charging time point can only rely on a reservation function of the electric automobile. Charging facilities cannot acquire charging demands of the automobiles, nor can they formulate corresponding strategies to actively formulate charging strategies, so as to further ensure orderly charging of the electric automobiles.

### SUMMARY

An objective of the present invention is to provide an interactive charging and discharging strategy of an electric automobile based on time and price weights. When the electric automobile is connected to a power grid, the power grid interacts with a user to acquire user demand preferences such as “time priority” and “price priority” for calculating a preference information entropy value and a corresponding weight while acquiring power parameters of the automobile. According to an electric power limit and information weight ranking in a current region, charging powers of the automobiles are calculated iteratively in real time, which ensures orderly charging of the electric automobiles under a limited regional power and increases a utilization rate.

The present invention adopts the technical solution specifically as follows:
step 1, setting, by a user, a time priority value mt and a price priority value mp of automobile charging, and normalizing the values into an interval [0,1] according to Equation (1) based on user-set maximum and minimum values to obtain [symbol] and [symbol] ,

$$\text{?} = \frac{m t - min ( m t )}{max ( m t ) - min ( m t )} , \text{?} = \frac{m p - min ( m p )}{max ( m p ) - min ( m p )} \qquad formula ( 1 )$$

step 2, acquiring information of an automobile at time t, such as indicators which are a requested charging power, a real-time charging power, a charging start time, a charging duration and an initial SOC for calculating an information entropy weight value zᵢ(t) of the automobile at the time t, specifically,
standardizing the automobile information first, where

$${\hat{X}}_{i , j} ( t ) = \frac{{X}_{i , j} ( t ) - min ( {X}_{i , j} ( t ) )}{max ( {X}_{i , j} ( t ) ) - min ( {X}_{i , j} ( t ) )} \qquad formula ( 2 )$$

X_{i,j} (t) expresses a real-time information item of an j^{th} class of an i^{th} automobile, k is a number of information indicator items acquired, j≤k, and \hat{X}_{i,j} (t) is a standardized value; and
then calculating the information entropy weight value zᵢ(t) of the automobile at the time t according to Equation (3);

$${z}_{i} ( t ) = {\sum }_{j = 1}^{k} {w}_{i , j} ( t ) \times {P}_{i , j} ( t ) \qquad formula ( 3 )$$

$$where , {w}_{i , j} ( t ) = \frac{1 - {S}_{i , j} ( t )}{k - {\sum }_{j = 1}^{k} {S}_{i , j} ( t )} ,$$

$${S}_{i , j} ( t ) = g \times {\sum }_{i = 1}^{n} {P}_{i , j} ( t ) \times ln ( {P}_{i , j} ( t ) ) ,$$

$${P}_{i , j} ( t ) = \frac{{\hat{X}}_{i , j} ( t )}{{\sum }_{i = 1}^{n} {\hat{X}}_{i , j} ( t )} , g = ln ( n ) .$$

step 3, acquiring a limited total power P₀(t) at the time t in this region, and calculating a sum P_{f}(t) of requested charging powers of all the automobiles according to Equation (4); if P_{f}(t)≤P₀(t), performing charging as needed without distributing the charging powers based on the weights; then re-entering step 2 for calculating a distributed charging power in a next time period; otherwise, entering step 4, where

$${P}_{f} ( t ) = {\sum }_{i = 1}^{n} {p}_{fi} ( t ) \qquad formula ( 4 )$$

in the equation, p_{f} is the requested charging power of the automobile;
step 4, calculating a power distribution weight value eᵢ at time t+1 according to Equation (5) based on the time priority value mt, the price priority value mp and the information weight value zᵢ of the charging automobile, and calculating a distributable power pₕ of the automobile according to Equation (6), where

$${e}_{i} ( t + 1 ) = f ( \text{?} , \text{?} ) \times {z}_{i} ( t ) \qquad formula ( 5 )$$

$${p}_{hi} ( t + 1 ) = {\hat{e}}_{i} ( t + 1 ) \times {P}_{0} ( t ) \qquad formula ( 6 )$$

where

$${\hat{e}}_{i} = \frac{{e}_{i}}{{\sum }_{i = 1}^{n} {e}_{i}} ,$$

$$f ( \text{?} , \text{?} ) = [ ( {zt}_{max} - {zt}_{min} ) \text{?} + {zt}_{min} ] \times [ ( {zp}_{min} - {zp}_{max} ) \text{?} + {zp}_{max} ] ,$$

ztₘₐₓ and ztₘᵢₙ are highest and lowest time priority weighting ratios respectively; and zpₘₐₓ and zpₘᵢₙ are highest and lowest price priority weighting ratios respectively; and
step 5, iteratively regulating an actual charging power p of the automobile by regression according to pₕ and ê, and grouping the automobile, where if p_{fi}≤pᵢ, the automobile is denoted into group a and recorded with a serial number being aₓ=i, 1≤x≤u (where u is a number of the automobiles in a case of p_{fi}≤pᵢ), and the actual charging power of the automobile is regulated as p_{fi}; if p_{fi}>pᵢ, the automobile is denoted into group b and recorded with a serial number being bₓ=i, 1≤x≤v (where v is a number of the automobiles in a case of p_{fi}>pᵢ); and a total number of the two groups of automobiles is equal to a total number of currently charging automobiles, i.e. u+v=n;
acquiring a real-time charging power p_{b}_{ₓ} of the automobile in group b every time interval Δt, calculating a power difference

$$\vert {p}_{{b}_{x}} ( t + Δ t ) - {p}_{{b}_{x}} ( t ) \vert ,$$

until the difference is smaller than pₜₕᵣₑ after time t₁; considering a stable charging power of the automobile without any more increase; at this time, distributing a redistributable residual power of the automobile to the automobiles in group a; and calculating a total redistributable residual power Pᵣₑₘ of group b according to Equation (7), where pₜₕᵣₑ is a charging power dynamic change threshold;

$${P}_{rem} = {\sum }_{x = 1}^{v} ( {p}_{{fb}_{x}} - {p}_{{b}_{x}} ) \qquad formula ( 7 )$$

regulating the real-time charging powers of the automobiles in group a according to Equation (8); and

$${p}_{{a}_{x}}^{′} = {p}_{{a}_{x}} + {\hat{e}}_{{a}_{x}} \times {P}_{r e m} \qquad formula ( 8 )$$

then re-entering step 2 for calculating a distributed charging power in the next time period.

Further, in step S1, the [symbol] and [symbol] values are related to the charging mode in a case that an available charging power in the region cannot meet the full-power charging demands of all automobiles; the [symbol] value being 1 indicates the time priority being highest, representing the most urgent charging demand; the [symbol] value being 0 indicates a lowest urgency case, representing that the automobile can fully accommodate charging power distribution dispatching; the [symbol] value being 1 indicates the price priority being highest, representing rejection of price increase regulation; the [symbol] value being 0 indicates the price priority being lowest, representing possibility of receiving price increase regulation; and the [symbol] value and the [symbol] value may be associated with different price coefficient values to ultimately determine a charging cost.

Further, in step S2, the information of the automobile at the time t includes, but not limited to, indicators such as the requested charging power, the real-time charging power, the charging start time, the charging duration and the initial SOC; and indicator items may be added as actually needed.

Further, in step S4, a time and price weight function f may be set as needed, for example:

$$f ( x , y ) = ft ( x ) \times fp ( y )$$

$$ft ( x ) = ( {zt}_{max} - {zt}_{min} ) x + {zt}_{min}$$

$$fp ( y ) = ( {zp}_{min} - {zp}_{max} ) y + {zp}_{max}$$

in the equation, ztₘₐₓ and ztₘᵢₙ are highest and lowest time priority weighting ratios respectively; and zpₘₐₓ and zpₘᵢₙ are highest and lowest price priority weighting ratios respectively.

Further, in step S5, Δt, tᵢ and pₜₕᵣₑ may all be set based on application, meeting that t₁ is smaller than a time interval between the time t+1 and the time t in step S4.

The present invention achieves the following technical effects: by introducing the user's “time” and “price” preference settings, the preference weights of the time and the price are associated with the distributable charging power. If the total charging power in the region is limited, and the total charging power of all the automobiles is larger than an upper limit, the information entropy weight value under a fair weight is calculated first according to the automobile information; and then the information entropy weight value is multiplied by the time and price weight function to obtain a new weight value; and the charging powers of all the automobiles are distributed according to the new weight value, which ensures on-demand distribution and maximum orderly charging in a case of limited resources.

### BRIEF DESCRIPTION OF DRAWINGS

FIG. 1 is a schematic flowchart of an electric automobile charging strategy method based on time and price weights provided by the present invention.

### DETAILED DESCRIPTION OF THE EMBODIMENTS

In order to make the objectives, the technical solutions and the advantages of the present invention more clearly and unambiguously, the present invention is specifically described below in reference with the embodiments. It should be understood that the following words are only the description of one or more specific implementations of the present invention, not a serious limitation for the protection claimed by the present invention.

The present invention is further described in combination with the drawings of the specification, as follows:

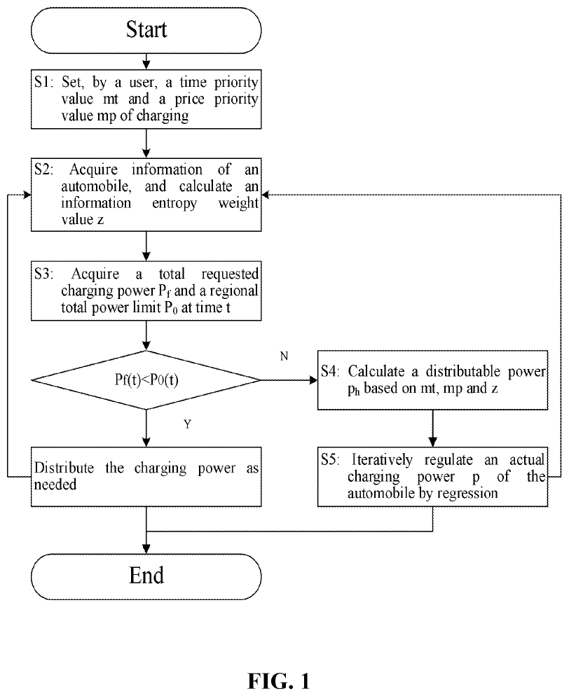

As shown in FIG. 1, an electric automobile charging strategy method based on time and price weights includes the following steps:
step 1, setting, by a user, a time priority value mt and a price priority value mp of automobile charging, and normalizing the values into an interval [0,1] according to Equation (1) based on user-set maximum and minimum values to obtain [symbol] and [symbol] ;

$$\text{?} - \frac{mt - min ( mt )}{max ( mt ) - min ( mt )} , \text{?} = \frac{mp - min ( mp )}{max ( mp ) - min ( mp )} \qquad formula ( 1 )$$

in actual use, mt and mp may be set to have 6 levels, being 0, 0.2, 0.4, 0.6, 0.8 and 1 respectively;
step 2, acquiring information of an automobile at time t, including 5 indicators such as a requested charging power, a real-time charging power, a charging start time, a charging duration and an initial SOC for calculating an information entropy weight value zᵢ(t) of the automobile at the time t, specifically,
standardizing the automobile information first, where

$${\hat{X}}_{i , j} ( t ) = \frac{{X}_{i , j} ( t ) - min ( {X}_{i , j} ( t ) )}{max ( {X}_{i , j} ( t ) ) - min ( {X}_{i , j} ( t ) )} \qquad formula ( 2 )$$

X_{i,j}(t) expresses a real-time information item of an j^{th} class of an i^{th} automobile, i≤n, j≤5, n is a total number of the automobiles, and \hat{X}_{i,j}(t) is a standardized value; and
calculating the information entropy weight value zᵢ(t) of the automobile at the time t according to Equation (3);

$${z}_{i} ( t ) = {\sum }_{j = 1}^{k} {w}_{i , j} ( t ) \times {P}_{i , j} ( t ) \qquad formula ( 3 )$$

$$where , {w}_{i , j} ( t ) = \frac{1 - {S}_{i , j} ( t )}{5 - {\sum }_{j = 1}^{5} {S}_{i , j} ( t )} ,$$

$${S}_{i , j} ( t ) = g \times {\sum }_{i = 1}^{n} {P}_{i , j} ( t ) \times ln ( {P}_{i , j} ( t ) ) ,$$

$${P}_{i , j} ( t ) = \frac{{\hat{X}}_{i , j} ( t )}{{\sum }_{i = 1}^{n} {\hat{X}}_{i , j} ( t )} , g = ln ( n ) ∘$$

step 3, acquiring a limited total power P₀(t) at the time t in this region, and calculating sum P_{f}(t) of requested charging powers of all the automobiles according to Equation (4); if P_{f}(t)≤P₀(t), performing charging as needed without distributing the charging powers based on the weights; then re-entering step 2 for calculating a distributed charging power in a next time period; otherwise, entering step 4, where

$${P}_{f} ( t ) = {\sum }_{i = 1}^{n} {p}_{fi} ( t ) \qquad formula ( 4 )$$

in the equation, p_{f} is the requested charging power of the automobile;
step 4, calculating a power distribution weight value eᵢ at time t+1 according to Equation (5) based on the time priority value mt, the price priority value mp and the information weight value zᵢ of the charging automobile, and calculating a distributable power pₕ of the automobile according to Equation (6), where in specific implementation, the time interval from t to t+1 may be set as 5 min;

$${e}_{i} ( t + 1 ) = f ( \text{?} , \text{?} ) \times {z}_{i} ( t ) \qquad formula ( 5 )$$

$${p}_{hi} ( t + 1 ) = {\hat{e}}_{i} ( t + 1 ) \times {P}_{0} ( t ) \qquad formula ( 6 )$$

where

$${\hat{e}}_{i} = \frac{{e}_{i}}{{\sum }_{i = 1}^{n} {e}_{i}} ,$$

$$f ( \text{?} , \text{?} ) = [ ( {zt}_{max} - {zt}_{min} ) \text{?} + {zt}_{min} ] \times [ ( {zp}_{min} - {zp}_{max} ) \text{?} + {zp}_{max} ] ,$$

ztₘₐₓ and ztₘᵢₙ are highest and lowest time priority weighting ratios respectively; and zpₘₐₓ and zpₘᵢₙ are highest and lowest price priority weighting ratios respectively; and it may be set that ztₘₐₓ=2.0, ztₘᵢₙ=0.1, zpₘₐₓ=2.5, and zpₘᵢₙ=0.5, and then the following equation is obtained

$$f ( \text{?} , \text{?} ) = ( 1.9 \text{?} + 0.1 ) \times ( 2.5 - 2 \text{?} )$$

step 5, iteratively regulating an actual charging power p of the automobile by regression according to pₕ and ê, and grouping the automobile, where if p_{fi}≤pᵢ, the automobile is denoted into group a and recorded with a serial number being aₓ=i, 1≤x≤u (where u is a number of the automobiles in a case of p_{fi}≤pᵢ), and the actual charging power of the automobile is regulated as p_{fi}; if p_{fi}>pᵢ, the automobile is denoted into group b and recorded with a serial number being bₓ=i, 1≤x≤v (where v is a number of the automobiles in a case of p_{fi}>pᵢ); and a total number of the two groups of automobiles is equal to a total number of currently charging automobiles, i.e. u+v=n;
acquiring a real-time charging power p_{b}_{ₓ} of the automobile in group b every time interval Δt, calculating a power difference

$$\vert {p}_{{b}_{x}} ( t + Δ t ) - {p}_{{b}_{x}} ( t ) \vert ,$$

until the difference is smaller than pₜₕᵣₑ after time t₁; considering a stable charging power of the automobile without any more increase; at this time, distributing a redistributable residual power of the automobile to the automobiles in group a; and calculating a total redistributable residual power Pᵣₑₘ of group b according to Equation (7), where pₜₕᵣₑ is a charging power dynamic change threshold; in implementation, it is set that Δt is 5 s, and t₁ is 25 s, which means calculating the power difference 5 times;

$${P}_{rem} = {\sum }_{x = 1}^{v} ( {p}_{{fb}_{x}} - {p}_{{b}_{x}} ) \qquad formula ( 7 )$$

regulating the real-time charging powers of the automobiles in group a according to Equation (8); and

$${p}_{{a}_{x}}^{′} = {p}_{{a}_{x}} + {\hat{e}}_{{a}_{x}} \times {P}_{rem} \qquad formula ( 8 )$$

then re-entering step 2 for calculating a distributed charging power in the next time period.

In step S1, the [symbol] and [symbol] values are related to the charging mode in a case that an available charging power in the region cannot meet the full-power charging demands of all automobiles; the [symbol] value being 1 indicates the time priority being highest, representing the most urgent charging demand; the [symbol] value being 0 indicates a lowest urgency case, representing that the automobile can fully accommodate charging power distribution dispatching; the [symbol] value being 1 indicates the price priority being highest, representing rejection of price increase regulation; the [symbol] value being 0 indicates the price priority being lowest, representing possibility of receiving price increase regulation; and the [symbol] value and the [symbol] value may be associated with different price coefficient values to ultimately determine a charging cost.

In step S2, the information of the automobile at the time t includes, but not limited to, indicators such as the requested charging power, the real-time charging power, the charging start time, the charging duration and the initial SOC; and indicator items may be added as actually needed.

In step S4, a time and price weight function f may be set as needed, for example:

$$f ( x , y ) = ft ( x ) \times fp ( y )$$

$$ft ( x ) = ( {zt}_{max} - {zt}_{min} ) x + {zt}_{min}$$

$$fp ( y ) = ( {zp}_{min} - {zp}_{max} ) y + {zp}_{max}$$

in the equation, ztₘₐₓ and ztₘᵢₙ are highest and lowest time priority weighting ratios respectively; and zpₘₐₓ and zpₘᵢₙ are highest and lowest price priority weighting ratios respectively.

In step S5, Δt, t₁ and pₜₕᵣₑ may all be set based on application, meeting that t₁ is smaller than a time interval between the time t+1 and the time t in step S4.

The innovation of the present invention lies in that the “time” and “price” preferences of the charging automobiles are introduced, which, combined with the information entropy weight values of the automobiles, form new charging power distribution weight values. If the regional charging power is limited and the total power of the automobiles is larger than the limit, the charging powers of various automobiles may be distributed based on the weight values. In a case of large time priority value and small price priority value of one automobile, a large charging power distribution weight value may be obtained, and then more charging power may be distributed. On the contrary, a small charging power distribution weight value may be obtained during a charging peak time, and then less charging power may be distributed. This method can achieve orderly and fair charging of the automobiles with limited regional power resources.

The above shows and describes the basic principle, the main characteristics and the advantages of the present invention. It should be understood by those skilled in the art that the present invention is not limited to the above embodiments, the above embodiments and the specification merely describe the principle of the present invention, and various changes and improvements can further be made for the present invention without departing from the spirit and scope of the present invention and all fall within the scope of the present invention as claimed. The scope of the present invention as claimed is defined by the appended claims and equivalents thereof.

What is claimed is:

1. An electric automobile charging strategy method based on time and price weights, comprising the following steps:
S1, setting, by a user, a time priority value mt and a price priority value mp of automobile charging, and normalizing the values into an interval [0,1] according to Equation (1) based on user-set maximum and minimum values to obtain [symbol] and [symbol] ;
$$\text{?} = \frac{mt - min ( mt )}{max ( mt ) - min ( mt )} , \text{?} = \frac{mp - min ( mp )}{max ( mp ) - min ( mp )} \qquad formula ( 1 )$$
S2, acquiring information of an automobile at time t, including indicators such as a requested charging power, a real-time charging power, a charging start time, a charging duration and an initial SOC for calculating an information entropy weight value zᵢ(t) of the automobile at the time t, specifically,
standardizing the automobile information according to Equation (2), wherein
$${\hat{X}}_{i , j} ( t ) = \frac{{X}_{i , j} ( t ) - min ( {X}_{i , j} ( t ) )}{max ( {X}_{i , j} ( t ) ) - min ( {X}_{i , j} ( t ) )} \qquad formula ( 2 )$$
X_{i,j} (t) expresses a real-time information item of an j^{th} class of an i^{th} automobile, k is a number of information indicator items acquired, j≤k, and \hat{X}_{i,j}(t) is a standardized value; and
calculating the information entropy weight value zᵢ(t) of the automobile at the time t according to Equation (3);
$${z}_{i} ( t ) = {\sum }_{j = 1}^{k} {w}_{i , j} ( t ) \times {P}_{i , j} ( t ) \qquad formula ( 3 )$$
$$where , {w}_{i j} ( t ) = \frac{1 - {S}_{i , j} ( t )}{k - {\sum }_{j = 1}^{k} {S}_{i , j} ( t )} ,$$
$${S}_{i , j} ( t ) = g \times {\sum }_{i = 1}^{n} {P}_{i , j} ( t ) \times ln ( {P}_{i , j} ( t ) ) ,$$
$${P}_{i , j} ( t ) = \frac{{\hat{X}}_{i , j} ( t )}{{\sum }_{i = 1}^{n} {\hat{X}}_{i , j} ( t )} , g = ln ( n )$$
S3, acquiring a limited total power P₀(t) at the time t of charging in this region, and calculating a sum P_{f}(t) of requested charging powers of all the automobiles according to Equation (4); if P_{f}(t)≤P₀(t), performing charging as needed without distributing the charging powers based on the weights; then re-entering step S2 for calculating a distributed charging power in a next time period; otherwise, entering step S4, wherein
$${P}_{f} ( t ) = {\sum }_{i = 1}^{n} {p}_{fi} ( t ) \qquad formula ( 4 )$$
in the equation, p_{f} is the requested charging power of the automobile;
S4, calculating a power distribution weight value eᵢ at time t+1 according to Equation (5) based on the time priority value mt, the price priority value mp and the information weight value zᵢ of the charging automobile, and calculating a distributable power pₕ of the automobile according to Equation (6); and
$${e}_{i} ( t + 1 ) = f ( \text{?} , \text{?} ) \times {z}_{i} ( t ) \qquad formula ( 5 )$$
$${p}_{hi} ( t + 1 ) = {\hat{e}}_{i} ( t + 1 ) \times {P}_{0} ( t ) \qquad formula ( 6 )$$
wherein
$${\hat{e}}_{i} = \frac{{e}_{i}}{{\sum }_{i = 1}^{n} {e}_{i}} , f ( \text{?} , \text{?} )$$
is a time and price weight function,
S5, iteratively regulating an actual charging power p of the automobile by regression according to pₕ and ê, and grouping the automobile, wherein if p_{fi}≤pᵢ, the automobile is denoted into group a and recorded with a serial number being aₓ=i, 1≤x≤u (wherein u is a number of the automobiles in a case of p_{fi}≤pᵢ), and the actual charging power of the automobile is regulated as p_{fi}; if p_{f}>pᵢ, the automobile is denoted into group b and recorded with a serial number being bₓ=i, 1≤x≤v (wherein v is a number of the automobiles in a case of p_{fi}>pᵢ); and a total number of the two groups of automobiles is equal to a total number of currently charging automobiles, i.e. u+v=n;
acquiring a real-time charging power p_{b}_{ₓ} of the automobile in group b every time interval Δt, calculating a power difference
$$\vert {p}_{{b}_{x}} ( t + Δ t ) - {p}_{{b}_{x}} ( t ) \vert ,$$
until the difference is smaller than pₜₕᵣₑ after time t₁; considering a stable charging power of the automobile without any more increase; at this time, distributing a redistributable residual power of the automobile to the automobiles in group a; and calculating a total redistributable residual power Pᵣₑₘ of group b according to Equation (7), wherein Pₜₕᵣₑ is a charging power dynamic change threshold;
$${P}_{rem} = {\sum }_{x = 1}^{v} ( {p}_{{fb}_{x}} - {p}_{{b}_{x}} ) \qquad formula ( 7 )$$
regulating the real-time charging powers of the automobiles in group a according to Equation (8); and
$${p}_{{a}_{x}}^{′} = {p}_{{a}_{x}} + {\hat{e}}_{{a}_{x}} \times {P}_{rem} \qquad formula ( 8 )$$
then re-entering step S2 for calculating a distributed charging power in the next time period.

2. The electric automobile charging strategy method based on the time and price weights according to claim 1, wherein in step S1, the [symbol] and [symbol] values are related to the charging mode in a case that an available charging power in the region cannot meet the full-power charging demands of all automobiles; the [symbol] value being 1 indicates the time priority being highest, representing the most urgent charging demand; the [symbol] value being 0 indicates a lowest urgency case, representing that the automobile can fully accommodate charging power distribution dispatching; the [symbol] value being 1 indicates the price priority being highest, representing rejection of price increase regulation; the [symbol] value being 0 indicates the price priority being lowest, representing possibility of receiving price increase regulation; and the [symbol] value and the [symbol] value may be associated with different price coefficient values to ultimately determine a charging cost.

3. The electric automobile charging strategy method based on the time and price weights according to claim 1, wherein in step S2, the information of the automobile at the time t includes, but not limited to, indicators such as the requested charging power, the real-time charging power, the charging start time, the charging duration and the initial SOC; and indicator items may be added as actually needed.

4. The electric automobile charging strategy method based on the time and price weights according to claim 1, wherein in step S4, the time and price weight function f may be set as needed, for example:
$$f ( x , y ) = ft ( x ) \times fp ( y )$$
$$ft ( x ) = ( {zt}_{max} - {zt}_{min} ) x + {zt}_{min}$$
$$fp ( y ) = ( {zp}_{min} - {zp}_{max} ) y + {zp}_{max}$$
in the equation, ztₘₐₓ and Ztₘᵢₙ are highest and lowest time priority weighting ratios respectively; and zpₘₐₓ and zpₘᵢₙ are highest and lowest price priority weighting ratios respectively.

5. The electric automobile charging strategy method based on the time and price weights according to claim 1, wherein in step S5, Δt, t₁ and pₜₕᵣₑ may all be set based on application, meeting that t₁ is smaller than a time interval between the time t+1 and the time t in step S4.
